(19) United States
(12) Patent Application Publication
(10) Pub. No.: US 2012/0199475 A1
(43) Pub. Date: Aug. 9, 2012

(54) PROCESSING APPARATUS WITH VERTICAL LIQUID AGITATION

(76) Inventors: Paul R. McHugh, Kalispell, MT (US); Gregory J. Wilson, Kalispell, MT (US); Bryan Puch, Kalispell, MT (US)

(21) Appl. No.: 13/023,317

(22) Filed: Feb. 8, 2011

(51) Int. Cl. C25D 19/00; B01F 13/00

(52) U.S. Cl. 204/273; 366/343

(57) ABSTRACT

A substrate or semiconductor wafer processing apparatus has an agitator plate adjacent to an upper end of a process vessel. A workpiece holder holds a workpiece in the vessel at a processing position above the agitator plate. A vertical actuator assembly supporting the agitator plate oscillates the agitator plate vertically. The agitator plate may also rotate while oscillating vertically. In one design, the agitator plate has a spiral vane and a spiral slot. In a related metal plating apparatus, electrodes and a dielectric field shaping unit are in the vessel, below the agitator plate, and a shield ring is adjacent to the upper end of the vessel, above the agitator plate.

### TECHNICAL FIELD

The field of the invention is apparatus and methods for agitating a processing solution to provide high velocity, controlled fluid flows at the surface of a microfeature workpiece or wafer that results in good mass-transfer rates, removal of bubbles or particulates, and/or high quality and high speed plating into recesses. Apparatus in accordance with the invention are suitable for cleaning, etching, plating, and other wet chemical processes used to manufacture devices having very small features.

### BACKGROUND

In many wet chemical processes, a diffusion layer forms adjacent to a process surface of a workpiece. The diffusion layer is a thin region of varying material or ion concentrations adjacent to the workpiece surface. The diffusion layer is often a significant factor in the quality and efficiency in wet chemical processing. It is created by the consumption or creation of material/ion species at the surface. The thickness of the diffusion layer dictates the mass-transfer rate of components/reactants to the surface. This can also influence organic additive transport and function. Thus the mass-transfer rate can be controlled by controlling the diffusion layer. A thinner diffusion layer, for example, results in a higher mass-transfer rate. Hence, the mass-transfer rate at the workpiece may be controlled to achieve the desired results. For example, many manufacturers seek to increase the mass-transfer rate to increase the etch rate and/or deposit rate, to reduce the time required for the processing cycles. The mass-transfer rate also plays a significant role in depositing alloys onto microfeature workpieces because the different ion species in the processing solution have different plating properties. Therefore, increasing or otherwise controlling the mass-transfer rate at the surface of the workpiece is important in depositing alloys and other wet chemical processes.

One technique for increasing or otherwise controlling the mass-transfer rate at the surface of the workpiece is to increase the relative velocity between the processing solution and the surface of the workpiece. Accordingly, some processing chambers have paddles or blades which translate or rotate in the processing solution adjacent to the workpiece to create a high-speed, agitated flow at the surface of the workpiece. In electrochemical processing applications, for example, the paddles typically oscillate next to the workpiece and are located between the workpiece and an anode in the plating solution.

While these designs have performed well in the past, certain engineering challenges remain in the design of this type of processing apparatus and related methods. One challenge relates to the location of the paddle relative to the plating shield often used to control workpiece edge plating uniformity. Typically, since the paddle must be located very close to the workpiece, the shield is necessarily located below the paddle, where it is less effective. Another challenge is that in processing chambers that hold the workpiece horizontally, and linearly reciprocate the paddle horizontally, relatively larger amounts of space are needed to accommodate the horizontal stroke length of the paddle. Some designs also require complex motion profiles, which add to the cost and complexity of the apparatus, and may also require longer horizontal travel distances.

### BRIEF DESCRIPTION OF THE DRAWINGS

In the drawings, the same reference number indicates the same element in each of the views.

FIG. 1 is a perspective view of a processing system including one or more of the present processing chambers.

FIG. 2 is an enlarged perspective view of one of the processing chambers shown in FIG. 1.

FIG. 3 is a perspective view of the processing chamber base alone.

FIG. 4 is a section view of the vessel assembly shown in FIG. 3.

FIG. 5 is a perspective view of the agitator plate assembly shown in part in FIGS. 3 and 4.

FIG. 6 is a perspective view of the agitator plate shown in FIGS. 3-5.

FIG. 7 is a top view of the agitator plate shown in FIG. 6.

FIG. 8 is a perspective view of an alternative design.

FIG. 9 is a perspective view of another alternative design.

FIG. 10 is a perspective view of yet another alternative agitator plate design.

### DETAILED DESCRIPTION

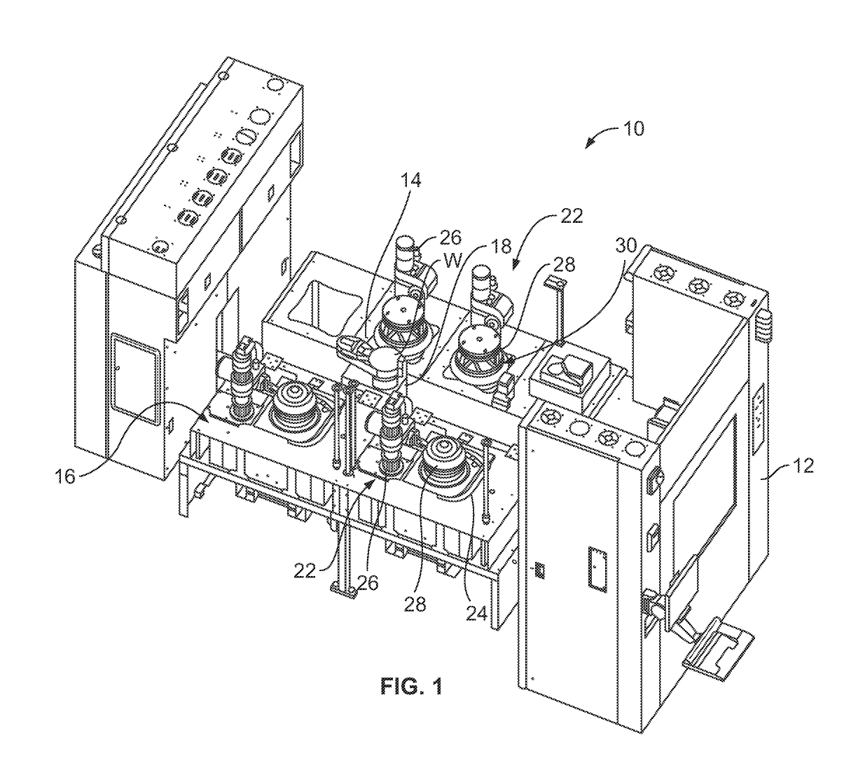

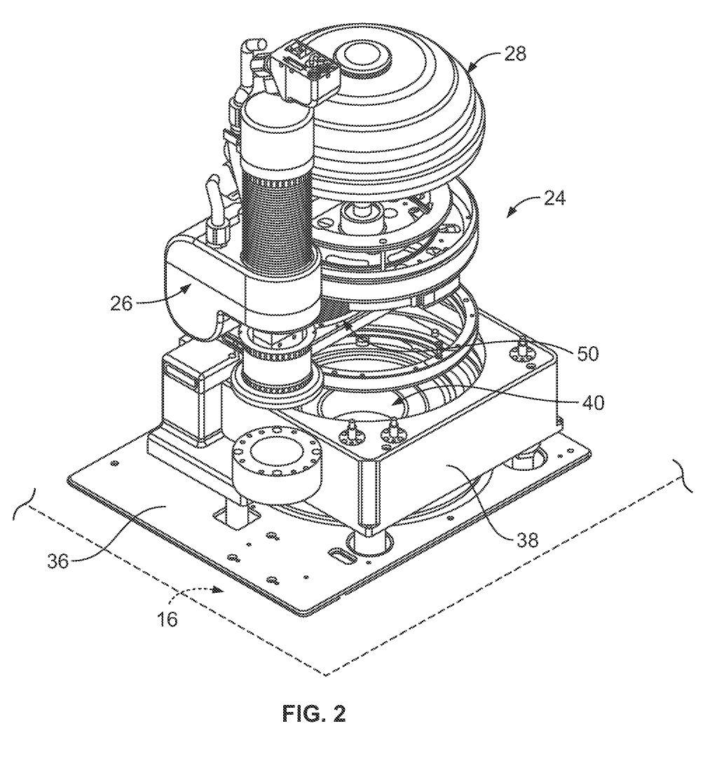

As shown in FIG. 1, a processing system 10 may include a robot 14 movable between decks 16. Processing chambers 24 are arranged on the decks 16. One or more of the processing chambers 24 includes a lift/rotate device 26 supporting a head 28 over a vessel assembly 30. A controller 12 may be linked to the various system components to monitor and control system operations and status. As shown in FIG. 2, the processing chamber 24 may include a chamber base 38 supported on a mounting plate 36 which in turn can be precision located on a deck 16.

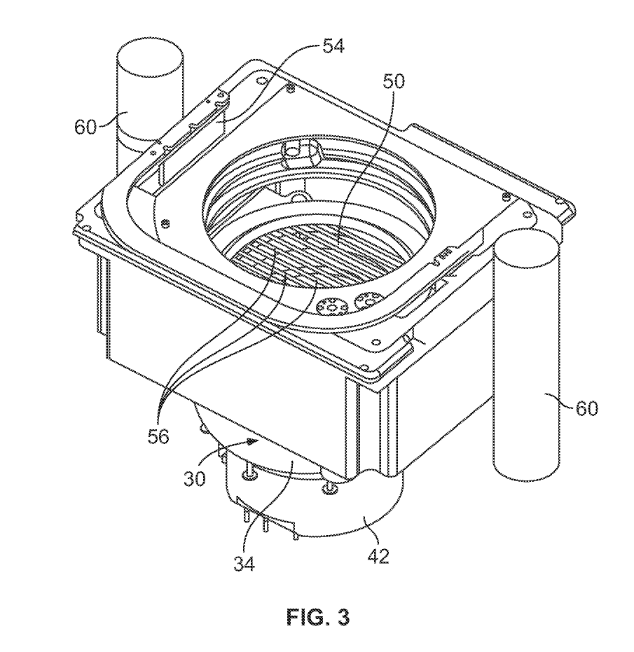

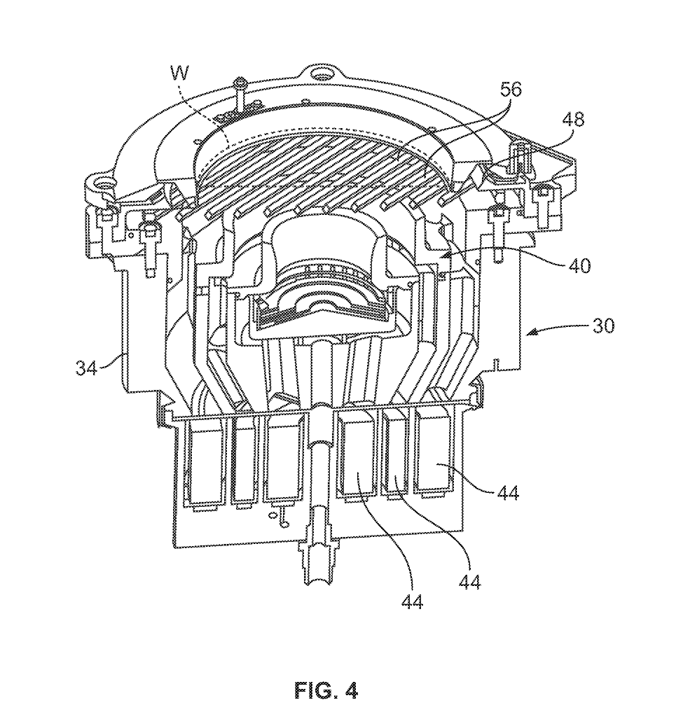

Referring to FIGS. 3 and 4, the vessel assembly 30 includes a process vessel 34 for holding a process liquid, such as an electrolyte. One or more inlets and outlets in the process vessel are connected to process liquid sources and drains, respectively, to supply and remove process liquid into and out of the process vessel 34. One or more electrodes 44, and a dielectric material field shaping element 40, may be provided in the process vessel 34, as described for example in U.S. Pat. No. 7,351,315 B2, incorporated herein by reference.

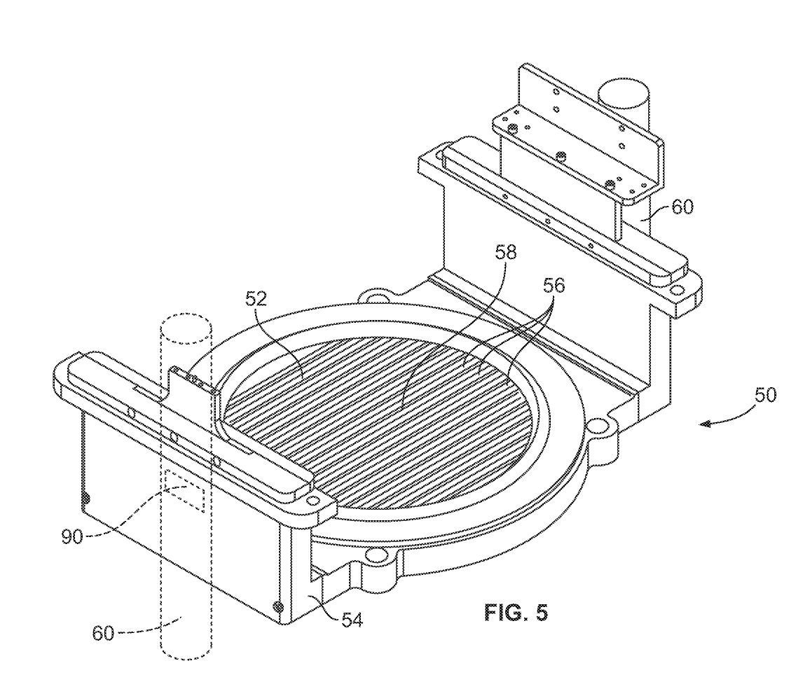

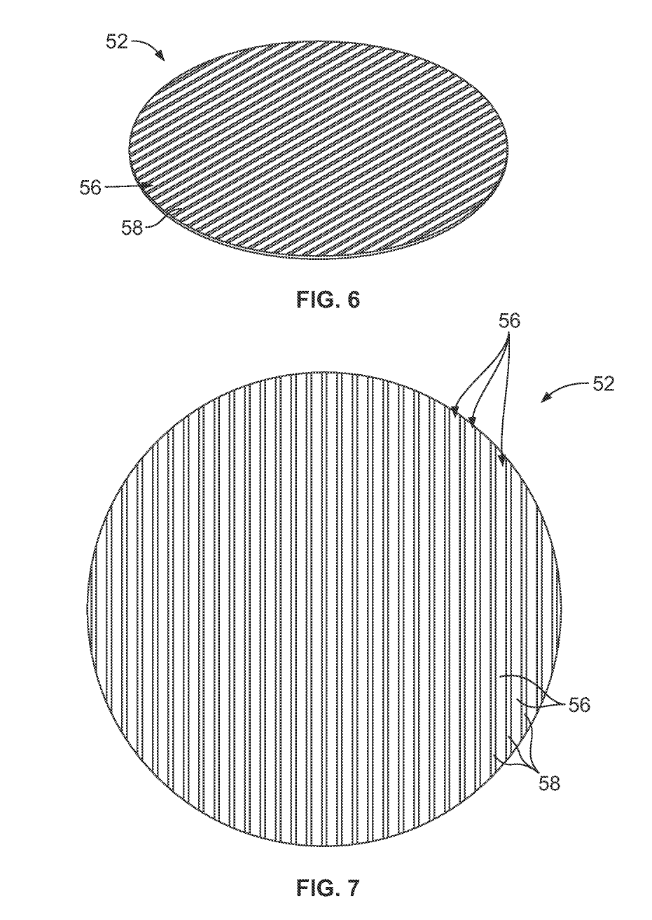

Turning to FIGS. 4-7, an agitator plate assembly 50 may be provided near the top of the process vessel 34. The agitator plate assembly 50 in the example shown includes a plate 52 having spaced apart blades or ribs 56, with openings or slots 58 between the blades 56, as shown in FIGS. 6 and 7. With this type of plate 52 having linear openings, the workpiece is rotated to avoid the potential for inadvertently imprinting a linear pattern onto the workpiece. The blades 56 may taper outwardly from the top to the bottom, so that the cross section of some or all of the blades is generally trapezoidal or triangular. The top, bottom and side surfaces of the blades may be straight or curved. The diameter of the plate 52 is comparable to the diameter of the workpiece. While the drawings show process chamber 24 shaped to process a round workpiece, the principals and design elements of the invention apply as well to processing workpieces having other shapes as well.

The plate 52 is attached to an agitator frame 54 supported by one or more vertical actuators 60. FIGS. 3 and 5 show a design using two vertical actuators 60 generally on opposite sides of the agitator frame 54, and generally aligned on a centerline of the plate 52. The vertical actuators 60 are preferably electric or pneumatic actuators. Since the vertical actuators 60 simply oscillate the agitator frame 54, and complex movement patterns are not needed, pneumatic actuators may be used, at significantly lower cost than electric actuators. In addition, in some designs only a single actuator may be used, with a passive tracking follower an the opposite side of the agitator frame 54, if needed.

In use, the system 10 and the process chamber 24 may operate in ways similar to known systems and process chambers, such as those described in US Patent Application Publication Nos. 2007/0151844 A1 and 2007/0144912 A1 and U.S. Pat. Nos. 7,351,315; 7,390,382; and 7,390,383, incorporated herein by reference. However, unlike these earlier designs, the agitator plate 52 in the process chamber 24 moves vertically, and not horizontally. Vertical movement of the agitator plate 52 towards and away from the workpiece W causes jets of process liquid to flow through the slots 58 in the plate. The up/down alternating direction of the flow enables strong mixing of the process liquid within the vessel 34, both above and below the agitator plate 52.

The enhanced flow resulting from the up/down movement of the plate 52 allows the plate to be positioned farther away from the workpiece while still achieving good performance results. With the agitator plate 52 positioned further away from the workpiece, for example, shields such as the annular di-electric shield 48 in FIG. 4, may be positioned above the agitator plate 52 and closer to the workpiece, where the shields are more effective at controlling wafer-edge plating uniformity.

The actuators 60 may be controlled by the controller 12 to move the agitator plate 52 at varying frequencies. Plate oscillation frequencies of about 2-20 or 3-10 Hz may be used. The plate oscillation frequency may also be modulated to better average mass-transfer non-uniformities. For example, the frequency may be set to a program 15 Hz for 3-10 seconds and then changed to 17 Hz for a similar time interval, before reverting back to the original 15 Hz.

The plate thickness may typically range from about 5 to 10 mm, with a 10-30% or 15-25% open area and a 10-18 mm or 12-15 mm pitch between the slots 58. The plate 52 may typically be vertically spaced apart from the workpiece by 10-30 mm. In designs where no interstitial elements are positioned between the workpiece and the plate 52, the spacing between them may be reduced to under 10 mm. The plate is oscillated with a stroke length of more than 6, 7, 8, 9 or 10 mm.

Vertical movement of the agitator plate is useful in through-silicon via applications. In one method, a liquid electrolyte is supplied into the vessel 34 via one or more inlets, and is collected from the vessel via one or more outlets or drains. Electrical current is supplied to primary electrodes in the vessel. The electric field in the vessel created by the primary electrodes may be shaped by a dielectric field shaping unit in the vessel above the primary electrodes. The workpiece or wafer can be supported on a rotor in a head attached to a lift/rotate mechanism. The rotor may rotate the workpiece during processing. An agitator plate adjacent to an upper end of the vessel and above the dielectric field shaping unit moves vertically towards and away from the workpiece. The agitator plate may have spaced apart slots and ribs. An optional secondary electrode or current thief ring in the vessel above the agitator plate and below the workpiece helps to provide more uniform metal plating at the edges of the workpiece. The workpiece holder may be adapted to hold a round flat workpiece having a diameter D, and with the agitator plate having a diameter greater or less than D. Vertical agitation may also be useful in through—photoresist plating of solder, tin-silver, Ni, copper studs, and similar materials.

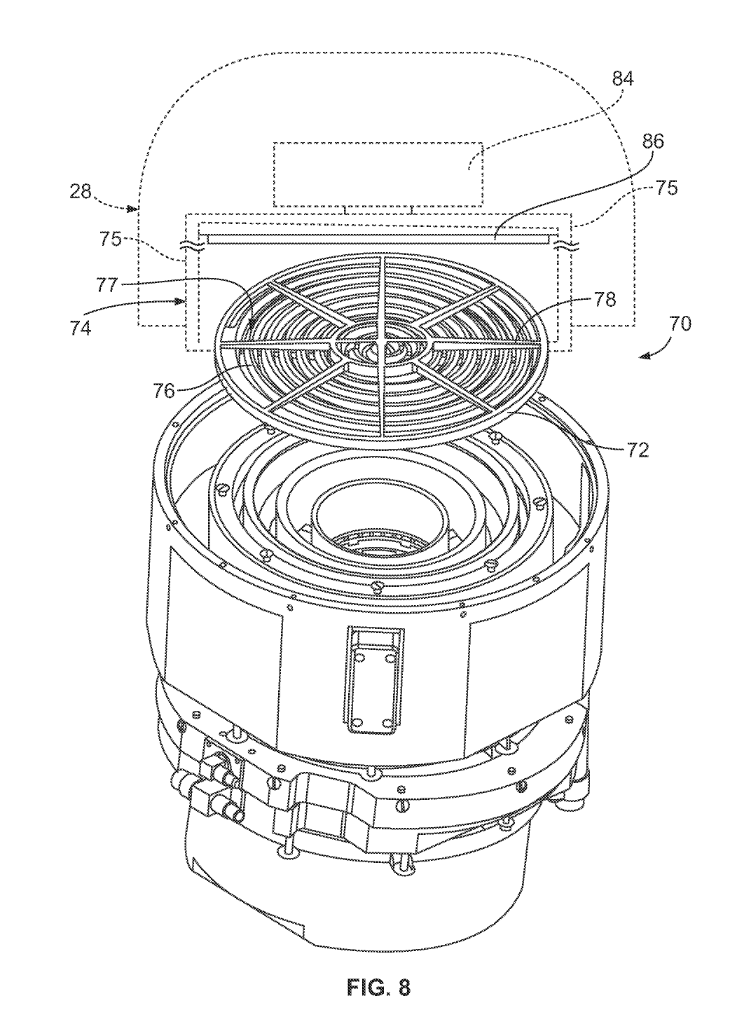

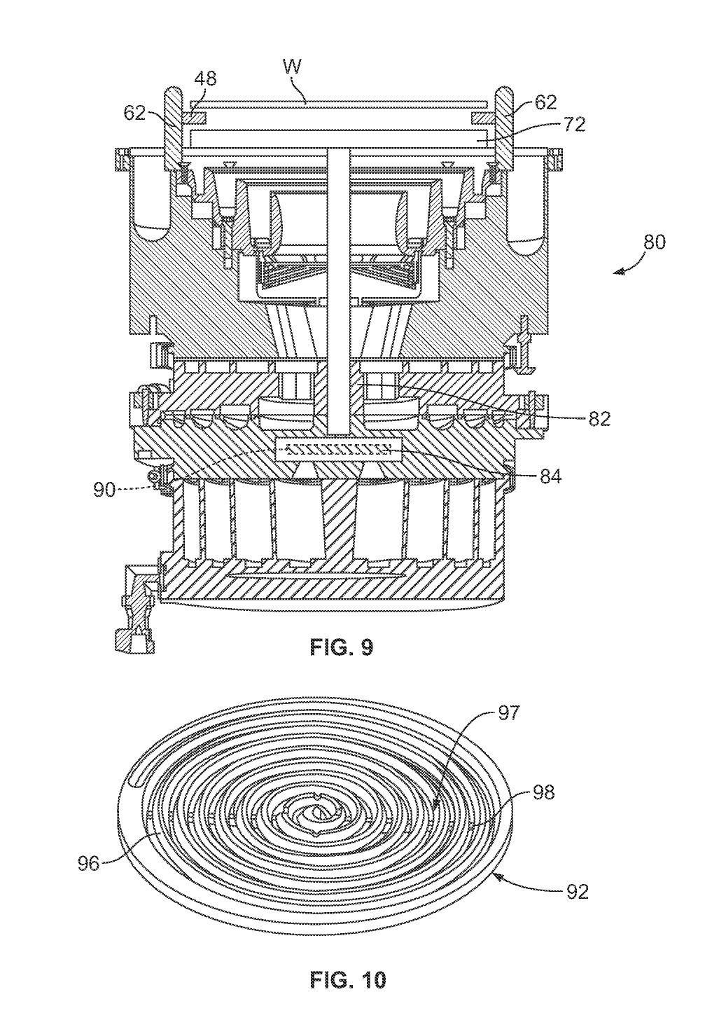

Turning to FIGS. 8-9, in alternative systems 70 and 80, an agitator plate 72 may have a series of circular arc vane segments 76 spaced apart by arcuate slots 77. In FIG. 8 the vane segments 76 are attached to and supported by radial arms 78. The vane segments may form continuous circular and concentric rings. Alternatively, the vane segments may extend on a constant diameter over a specified arc length, and then shift radially inwardly or outwardly over an adjoining arc length, in a radially staggered design. For example, one half of the plate may have vane segments 76 or correspondingly slots 77 between the vane segments, that are centered at 10, 20, 30 mm etc. with the other half of the plate having the slots or vane segments centered at 5, 15, 25 mm etc. The vane segments 76 and slots 77, whether continuous or staggered, may alternatively have an oval shape, instead of a circular shape. Oval-shaped vanes may be preferred for averaging both mass-transfer and the electric field when the workpiece is rotated.

The agitator plate 72 may be driven vertically via a fixture or frame attached to the edges of the agitator plate 72, as shown in FIG. 5. The agitator plate may alternatively be driven vertically by an actuator or motor 84 from a central attachment point, as shown in FIGS. 8 and 9. In FIG. 8, the agitator plate 72 is attached to an upper fixture 74 in the head 28. The upper fixture 74 is oscillated vertically by the actuator 84 to agitate the process liquid, as described above. The actuator 84 may also rotate the upper fixture 74 as it simultaneously oscillates vertically, to provide more uniform processing. The upper fixture 74 is attached to the agitator plate by sidearms 75, which provide clearance for the workpiece to be loaded into and removed from a fixed or rotatable wafer holder 86 positioned above the agitator plate 72.

FIG. 9 shows a similar design, but with the agitator plate 72 supported from below on a lower center shaft 82 in the vessel assembly 80. The actuator 84 may be electric or pneumatic. FIG. 9 also shows a cylindrical sidewall 62 surrounding the agitator plate 72. The sidewall 62 helps to prevent process liquid from flowing out around the sides of the agitator plate, rather than through the slots or openings in the plate. As also shown in FIG. 9, a shield or current thief 48 may be positioned above the agitator plate 72 and below the workpiece W.

FIG. 10 shows an alternative agitator plate 92 having a single spiral vane 96 running from near the center continuously to the outer edge of the agitator plate 92, forming corresponding spiral spaces or through openings 97 in the agitator plate 92. Alternatively, two, three or more spiral vanes may be used. Arms 98 may extend outwardly, radially or at an angle or on a curve, to support the spiral vane 96. The cross section shape of the spiral vane(s) may taper inwardly from a central vertical location toward the top and bottom of the vane. For example, the spiral vane may have a generally hexagonal or octagonal cross section. Vane designs with cross sections that taper inwardly from the center of the vane towards the top and/or bottom of the vane provide a more streamlined shape and reduce the force needed to move the vane through the process liquid. This reduces stress on the agitator plate material and also reduces the loads on the actuator 84. The circular vane segments 76 in FIG. 8 may also have this shape.

The spacing between each coil of the spiral vane may be constant, as shown in FIG. 10, or it may be varied, with greater spacing between adjacent coils of the vane provided closer to the center, or closer to the outer edge of the vane. Similarly, the cross section of the vane may remain constant, or it may be varied. The features and operation of the design shown in FIGS. 1-7 apply as well to the design shown in FIGS. 8-10, and vice-versa. Instead of having circular, oval or spiral vanes or vane segments, the agitator plate may have a pattern of holes similar to a conventional diffuser plate, but with up/down vertical movement.

The vertical agitation movement described above may also be combined with horizontal agitation movement. For example, as shown in FIGS. 5 and 9, one or more horizontal actuators 90 may be directly or indirectly attached to the agitator plate 52 or 72. The vertical actuator(s) 60 and the horizontal actuator(s) 90 may then be activated simultaneously. Moving the agitator plate in two dimensions may improve mass-transfer uniformity and help to average out non-uniformity, especially towards the center of the workpiece. The combined vertical/horizontal agitation movement may also be further combined with rotation of the workpiece. The horizontal actuator(s) 90, if used, may be located in a lower section of the vessel assembly 80, as shown in FIG. 9, or closer to the top end of the center shaft 82 shown in FIG. 9. The horizontal actuator(s) 90 may similarly be located in, or associated with, the vertical actuator(s) 60 as shown in FIG. 5, or it may be located on the agitator plate assembly 50, such as on the agitator frame 54 shown in FIG. 5. Alternatively, the vertical and/or horizontal actuator(s) may be in the head 28.

If combined vertical/horizontal agitation is used, the oscillation amplitude or movement and frequency of the vertical and horizontal components may be independently selected. For some applications, the horizontal movement can be set to an oscillation frequency of from about 0.5, 0.2 or 0.1 to 0.05 of the vertical oscillation frequency. The horizontal oscillation movement may also be less than the vertical oscillation movement, with the horizontal oscillation movement typically being less than 10 mm.

The terms workpiece and wafer here refer to substrates on and/or in which microelectronic devices or other microdevices are integrally formed. Typical microdevices include microelectronic circuits or components, thin-film recording heads, data storage elements, microfluidic devices, and other products. Micromachines or micromechanical devices are included within this definition because they are manufactured using much of the same technology that is used in the fabrication of integrated circuits. The substrates can be semiconductor materials (e.g., doped silicon wafers or gallium arsenide wafers), nonconductive pieces (e.g., various ceramic or glass substrates), or conductive pieces. In some cases, the workpieces are generally round and in other cases, the workpieces have other shapes, including rectilinear shapes. The term shield here means an insulating or di-electric material element.

Thus, novel apparatus and methods have been shown and described. Various changes and substitutions can of course be made without departing from the spirit and scope of the invention. The invention, therefore, should not be limited, except by the following claims, and their equivalents.

1. Processing apparatus comprising:
a vessel having one or more processing liquid inlets and outlets;
an agitator plate adjacent to an upper end of the vessel;
a workpiece holder adapted to hold a workpiece in the vessel at a processing position above the agitator plate; and
a vertical actuator assembly supporting the agitator plate and adapted to move the agitator plate vertically.

2. The apparatus of claim 1 further comprising one or more electrodes in the vessel and a dielectric field shaping unit in the vessel, below the agitator plate, and a shield ring adjacent to the upper end of the vessel, above the agitator plate.

3. The apparatus of claim 1 wherein the agitator plate comprises a spiral vane.

4. The apparatus of claim 3 with agitator plate further including a plurality of arms attached to the spiral vane.

5. The apparatus of claim 1 further comprising a head movable into a position over the vessel and with the vertical actuator assembly in the head.

6. The apparatus of claim 5 with the vertical actuator assembly further comprising a rotation motor for rotating the agitator plate.

7. The apparatus of claim 1 with the agitator plate having 10-30% open area, between the ribs.

8. The apparatus of claim 1 with the processing position at least 10 mm above the agitator plate, when the agitator plate is closest to the processing position.

9. The apparatus of claim 1 with the vertical actuator assembly including a shaft attached to a central location of the agitator plate.

10. The apparatus of claim 1 with the workpiece holder including a rotor for rotating the workpiece.

11. The apparatus of claim 10 wherein the agitator plate comprises a plurality of radially spaced apart oval-shaped rings.

12. The apparatus of claim 6 with the vertical actuator assembly including a linear actuator having a stroke length of less than 15 mm.

13. The apparatus of claim 1 with the vertical actuator adapted to oscillate the agitator plate at 3-10 Hz.

14. The apparatus of claim 1 with the workpiece holder adapted to hold a round flat workpiece having a diameter D, and with the agitator plate having a diameter less than D.

15. The apparatus of claim 3 with the vane having a cross section shape tapering toward the top and/or the bottom of the vane.

16. The apparatus of claim 3 with the spiral vane having a pitch of 12-15 mm between a centerline of a first spiral vane segment and a centerline of an adjacent radially spaced apart second spiral vane segment generally parallel to the first spiral vane segment.

17. Apparatus for electrochemically processing a semiconductor substrate workpiece, comprising:
a vessel for holding a processing liquid, with the vessel having one or more processing liquid inlets and outlets;
one or more primary electrodes in the vessel;
a dielectric field shaping unit in the vessel above the primary electrodes;
an agitator plate adjacent to an upper end of the vessel and above the dielectric field shaping unit;
a workpiece holder movable to place a workpiece held by the workpiece holder in a processing position in the vessel above the agitator plate;
at least one shield in the vessel positioned above the agitator plate and below the processing position; and
an agitator plate vertical oscillator supporting the agitator plate and moving the agitator plate vertically towards and away from the processing position.

18. The apparatus of claim 17 with the agitator plate having a spiral slot.

19. Processing apparatus comprising:
a vessel having one or more processing liquid inlets and outlets;
an agitator plate adjacent to an upper end of the vessel, with the agitator plate having a spiral vane;
a workpiece holder adapted to hold a workpiece in the vessel at a processing position above the agitator plate;
an actuator assembly supporting the agitator plate and adapted to oscillate the agitator plate vertically, and to also rotate the agitator plate;
one or more electrodes in the vessel and a dielectric field shaping unit in the vessel, below the agitator plate; and
a shield ring adjacent to the upper end of the vessel, above the agitator plate.

20. The apparatus of claim 19 with the processing position at least 10 mm above the agitator plate, when the agitator plate is closest to the processing position.
